(19) United States
(12) Patent Application Publication
(10) Pub. No.: US 2026/0365907 A1
(43) Pub. Date: Nov. 19, 2026

(54) RHEOLOGY MODIFIER FOR INVERT EMULSION OIL-BASED DRILLING FLUID SYSTEMS

(71) Applicant: SAUDI ARABIAN OIL COMPANY, Dhahran (SA)

(72) Inventors: Vikrant Wagle, Dhahran (SA); Kushabhau Teke, Al-Khobar (SA); Abdullah Al-Yami, Dhahran (SA); Ali Safran, Dhahran (SA)

(73) Assignee: SAUDI ARABIAN OIL COMPANY, Dhahran (SA)

(21) Appl. No.: 19/208,876

(22) Filed: May 15, 2025

(51) Int. Cl. C09K 8/36

(52) U.S. Cl. CPC C09K 8/36

(57) ABSTRACT

A composition for an invert emulsion oil-based drilling fluid formulation includes an invert emulsion having an oil phase and an aqueous phase, the oil phase including an oleaginous fluid; a solid viscosifier that is an organophilic clay-based viscosifier; and a liquid viscosifier that is a fatty dimer amine. A method for introducing a drilling fluid into a wellbore includes introducing an invert emulsion oil-based drilling fluid formulation including an oil phase, an aqueous phase, a solid viscosifier including an organophilic clay-based viscosifier, and a liquid viscosifier including a fatty dimer amine in the wellbore, and circulating the invert emulsion oil-based drilling fluid formulation in the wellbore.

### BACKGROUND

Invert emulsion oil-based fluids have been developed that can be used as drilling fluids for high pressure and high temperature (HPHT) sections of a downhole environment where water-based mud is not an option due to extreme drilling conditions. In addition, when drilling highly reactive shale sections, invert emulsion oil-based fluids have been used as drilling fluids to stabilize the shale. Rheology is an important property of drilling fluids, as it is responsible to suspend solids and carry cuttings to the surface. Drilling fluids without optimum rheological properties may cause several issues like solids settlings, barite sagging, and cuttings build up.

An invert emulsion is an oil-based emulsion of an oil phase and an aqueous phase known as a water-in-oil emulsion. Organophilic clays are conventionally used as viscosifiers for invert-emulsion oil-based drilling fluids. The conventional organoclay viscosifier may fail to impart sufficient low-end rheology to the oil-based mud. This may result in insufficient hole cleaning and an increased tendency for barite sag. Accordingly, there exists a need to boost the rheology of invert-emulsion oil-based mud including organophilic clays.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a composition of an invert emulsion oil-based drilling fluid formulation. The composition may include an invert emulsion comprising an oil phase and an aqueous phase, the oil phase including an oleaginous fluid; a solid viscosifier that is an organophilic clay-based viscosifier; and a liquid viscosifier that is a fatty dimer amine.

In another aspect, embodiments disclosed herein relate to a method of introducing a drilling fluid into a wellbore. The method may include introducing an invert emulsion oil-based drilling fluid formulation including an oil phase, an aqueous phase, a solid viscosifier including an organophilic clay-based viscosifier, and a liquid viscosifier including a fatty dimer amine in the wellbore, and circulating the invert emulsion oil-based drilling fluid formulation in the wellbore.

Other aspects and advantages of the claimed subject matter will be apparent from the following description and the appended claims.

### BRIEF DESCRIPTION OF DRAWINGS

FIG. 1 depicts a structure of a C36 fatty dimer amine, according to one or more embodiments.

FIG. 2 is a flowchart of a method, according to one or more embodiments.

FIG. 3 is a schematic illustration of a well environment in accordance with one or more embodiments.

FIG. 4 shows a graph of rheological properties of a drilling fluid formulation, according to one or more embodiments.

### DETAILED DESCRIPTION

One or more embodiments in accordance with the present disclosure generally relate to a drilling fluid (“mud”) including an organophilic clay and a fatty dimer amine as a rheology modifier (also known as a viscosifier). One or more embodiments relate to invert emulsion oil-based drilling fluid formulation including the organophilic clay and the fatty dimer amine, and related methods that may improve yield point, low shear rheology, and electrical stability of these drilling fluids, among other things. “Low shear” means a shear rate measured at 3 revolutions per minute (rpm) and 6 rpm as known to those of ordinary skill in the art.

In particular, when drilling formations at “HPHT” (high pressure, high temperature) conditions, such as a shale section of a formation at HPHT, an invert emulsion (water-in-oil or W/O emulsion) oil-based drilling fluid may be used to stabilize the reactive formation. “HPHT” or “high pressure/high temperature” in describing wellbore conditions may include a pressure of greater than or equal to 5,000 psi, a bottomhole or a section temperature of greater than or equal to 150 °F, or a combination of both.

Conventional viscosifiers may be added to a drilling fluid to provide a desired rheological property for drilling operations. However, conventional viscosifiers may contain a high content of solids. When this high content of solids is added to the drilling fluid, formation or equipment damage may result. A high content of solids also contributes to a higher circulating density than a low content of solids.

In addition, a conventional viscosifier under HPHT conditions may not maintain a desired rheological property when added to a drilling fluid. Failure to maintain a desired rheological property may result in solids settling, barite sagging, and cuttings build up within the drilling fluid or wellbore. A “desired rheological property” includes improved low shear rheology, according to one or more embodiments of the present disclosure (such as improved low shear rheology when using a composition including an organophilic clay and a fatty dimer amine compared to low shear rheology when using a composition without an organophilic clay and a fatty dimer amine). Low shear rheology may include one or more rheological property according to one or more embodiments of the present disclosure, especially in high density muds. As used herein, “low shear rheology” refers to a property of the mud when the agitation or shear rate is low, for example, as measured by using a FANN® Model 35 viscometer at 3 or 6 rpm. As may be appreciated by those skilled in the art, while the low shear rheological properties are described in detail in the present disclosure, improvements in rheological properties at higher shear rates may also be achieved by the compositions disclosed herein.

An improved low shear rheology may include having a viscosity of from 8 to 20 centipoise (cP) (at 6 rpm) and a viscosity of from 7 to 20 cP (at 3 rpm). In addition, low shear rheology may include a yield point in a range from 10 to 40 pounds per hundred square feet (lb/100 ft²); a low shear yield point in a range from 7 to 20 pounds per hundred square feet (lb/100 ft²); a 10 second (sec.) gel strength may be in a range from 7 to 20 lb/100 ft²; a 10 minute (min.) gel strength in a range from 7 to 251b/100 ft²; and an electrical stability in a range from 400 to 2000 volts.

### Invert Emulsion Oil-Based Drilling Fluid Formulation

Embodiments of the present disclosure are directed to a composition of an invert emulsion oil-based drilling fluid formulation. The drilling fluid formulation may include an invert emulsion comprising an oil phase and an aqueous phase. The oil phase may include an oleaginous fluid. The drilling fluid formulation may include a solid viscosifier. The solid viscosifier may be an organophilic clay-based viscosifier. The drilling fluid formulation may include a liquid viscosifier. The liquid viscosifier may be a fatty dimer amine.

The invert emulsion oil-based drilling fluid formulation may include an oil phase with an oleaginous fluid such as crude oil, condensates, light hydrocarbon liquids, fractions thereof, derivatives thereof, and others. In one or more embodiments, the oil phase includes a dearomatized mineral oil. An example of a dearomatized mineral oil is Safra oil (SaudiSol, Gulf Chemicals and Industrial Oils Co., Saudi Arabia). In one or more embodiments, Safra oil ranges from 60 to 95 vol % of the overall composition volume (volume expressed in barrels).

The invert emulsion oil-based drilling fluid formulation may include an inverted phase, also called an aqueous phase. The water of the aqueous phase may be any form of water, including, but not limited to, deionized water; filtered or raw fresh waters; mineral waters; filtered, raw or synthetic seawater; brackish water; synthetic or natural brines; salt water; formation water; and produced water. The water may contain an amount of organics from natural or artificial sources as long as the function of the composition, which is to provide the invert emulsion, is not inhibited. The water may contain an amount of minerals or metals from natural or artificial sources as long as the function of the composition is not inhibited. The water may contain an amount of monovalent ions, multivalent ions, and combinations thereof.

In one or more embodiments, the aqueous phase is a brine, such as a calcium chloride anhydride-based brine. The brine may be in a range of 5 to 40 vol % compared to the total volume of the drilling fluid formulation.

An invert emulsion oil-based drilling fluid formulation may include a solid viscosifier. As used herein, a “solid viscosifier” may be a solid or a mixture of a solid with a liquid. If in the form of a mixture of a solid with a liquid, the mixture may be a suspension of the solid in the liquid. The solid viscosifier may be an organophilic clay-based viscosifier. Non-limiting examples of the organophilic clay-based viscosifier may include organo-montmorillonite, organo-sepiolite, organo-palygorskite, organo-hectorite, or organo-attapulgite. The organophilic clay-based viscosifier may be present in the invert emulsion oil-based drilling fluid formulation in an amount ranging from 0.1 to 20 parts per billion (ppb).

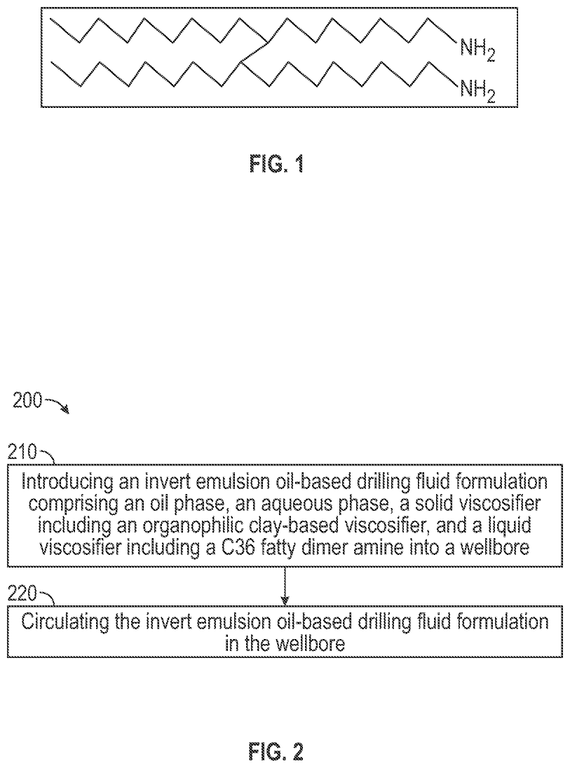

An invert emulsion oil-based drilling fluid formulation may include a liquid viscosifier. The liquid viscosifier may be a fatty dimer amine with a carbon length ranging from C8 to C72. In one or more embodiments, the fatty dimer amine has a carbon length ranging from C36 to C54. The liquid viscosifier may be a fatty trimer amine with a carbon length ranging from C36 to C54. In one or more embodiments, the liquid viscosifier is a C36 fatty dimer amine. A structure of the C36 fatty dimer amine is shown in FIG. 1. In one or more embodiments, the liquid viscosifier is Priamine 1074® (Croda) ((1E,19E)-10,11-dioctylicosa-1,19-diene-1,20-diamine), as shown in FIG. 1. The liquid viscosifier may be present in the invert emulsion oil-based drilling fluid formulation in a concentration ranging from 0.1 to 20 ppb.

In one or more embodiments, an invert emulsion oil-based drilling fluid formulation may comprise one or more additives. The additive may include but is not limited to a weighting agent, a friction reducer, a filtration control agent, an emulsion activator, a primary emulsifier, a secondary emulsifier, and combinations thereof. Such additives and combinations thereof are known in the art.

A weighting agent refers to finely divided solid material that is used to increase the density of the invert emulsion oil-based drilling fluid formulation. Non-limiting examples of weighting agents include aragonite, bentonite, barite, barium chloride, barium hydroxide, barium oxide, barium sulfate, calcite, calcium carbonate, dolomite, hematite, ilmenite, iron carbonate, iron oxides, lead carbonate, manganese oxides, siderite, zinc carbonate, zinc oxide, zirconium oxide, and other various minerals. In one or more embodiments, the additive includes barite or manganese tetroxide as a weighting agent. In one or more embodiments, the weighting agent is provided in a concentration range of from 0.5 to 300 parts per billion (ppb) in the overall composition.

A filtration control agent that may be added in the invert emulsion oil-based drilling fluid formulation may include but is not limited to modified lignites, asphalts, gilsonites, polymeric fluids, organolignite, polymeric solids and fluids, and combinations thereof. In one or more embodiments, the additive includes VERSATROL® (Schlumberger, USA) as a filtration control agent. In one or more embodiments, the filtration control agent is provided in a concentration range of from 0.1 to 20 ppb.

An emulsion activator refers to a component that activates the emulsifier, which then stabilizes the emulsion and aids in the formation of the invert emulsion. The emulsifier may be a component used in producing an oil-based or synthetic oil-based drilling fluid that forms an invert emulsion. The emulsifier may lower the interfacial tension between oil and water. For example, emulsifiers may be a primary emulsifier or a secondary emulsifier, where the secondary emulsifier may be used alone or in combination with another emulsifier in producing an invert emulsion. Emulsifiers may include calcium fatty-acid soaps made from various fatty acids, and/or derivatives such as amides, amines, amidoamines and imidazolines made by reactions of fatty acids, and various ethanolamine compounds.

In one or more embodiments, the primary emulsifier is a blend of fatty acid and hydrocarbons, such as VERSAMUL® (Schlumberger, USA). The hydrocarbon blend may include mineral oil, petroleum distillates, and raffinates. The primary emulsifier is added to an invert emulsion oil-based drilling fluid (mud) formulation to emulsify water in oil and to uniformly distribute water droplets. The primary emulsifier concentration may be 0.1 to 30 ppb of the total composition. In one or more embodiments, the secondary emulsifier is VERSACOAT® (Schlumberger, USA). The secondary emulsifier concentration may be 0.1 to 30 ppb of the total composition. One of ordinary skill in the art will appreciate other known examples of (primary or secondary) emulsifiers.

In one or more embodiments, the invert emulsion oil-based drilling fluid formulation does not include carboxylic acids. The inclusion of carboxylic acids may result in an increase in viscosity of the drilling fluid. The increase in the viscosity may result in an increase in a circulating density.

In one or more embodiments, the invert emulsion oil-based drilling fluid formulation does not include ureas. Ureas are known to be low gravity solids. Low gravity solids may increase the plastic viscosity of the drilling fluid formulation. An increase in the plastic viscosity may result in a higher equivalent circulating density during drilling operations.

Method of Introducing Drilling Fluid into Wellbore

One or more embodiments of the present disclosure describe a method of introducing an invert emulsion oil-based drilling fluid formulation into a wellbore. A flowchart of the method 200 is depicted in FIG. 2. The method 200 includes, at block 210, introducing an invert emulsion oil-based drilling fluid formulation comprising an oil phase, an aqueous phase, a solid viscosifier including an organophilic clay-based viscosifier, and a liquid viscosifier including a fatty dimer amine in the wellbore. The drilling fluid formulation, according to one or more embodiments, is mixed before introducing into the wellbore. Mixing may include adding each component as listed in Table 1 below for a period of time prior to adding the next component. Mixing may be done at a speed of at least 5000 rpm.

Mixing may include adding mineral oil based on the oil to the water ratio (OWR). The OWR may range from 50:50 vol % to 95:5 vol %. A primary emulsifier, a secondary emulsifier, and lime may be mixed in an amount ranging from 1 to 20 ppb each. An organophilic lignite may be mixed in an amount ranging from 0.1 to 20 ppb. Calcium chloride may be mixed in based on OWR and a salinity of the invert emulsion oil-based drilling fluid formulation. The salinity may be adjusted to range from 10% to 35% by weight. Mixing may include adding barite. The amount of barite may be based on the density of the drilling fluid formulation. Barite may be a weighting agent. Other weighting agents may be included. Non-limiting examples of weighting agents may include barite, manganese tetroxide, calcium carbonate, or hematite. The invert emulsion oil-based drilling fluid formulation may be stored for up to one week in a laboratory setting and a longer time period in the field. The invert emulsion oil-based drilling fluid formulation may also be recycled for reuse.

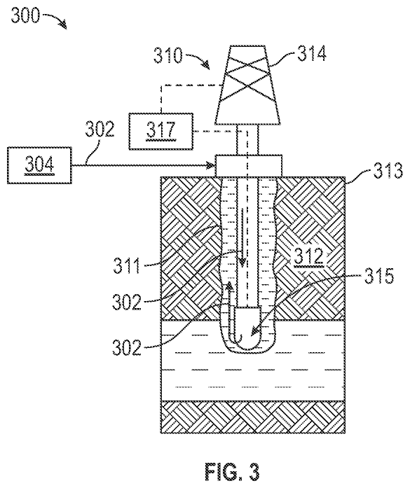

FIG. 3 depicts a well environment 300 in which the compositions and methods disclosed herein may be used in accordance with one or more embodiments of the present disclosure. A well system 310 may include a well 311 being drilled through a subsurface formation (“formation”) 312 to a hydrocarbon-bearing layer of the formation beneath the earth's surface (“surface”) 313. The formation 312 may include different layers of rock having varying characteristics, such as varying degrees of permeability, porosity, capillary pressure, and resistivity. In the case of the well system 310 being operated as a production well, the well system 310 may facilitate the extraction of hydrocarbons (or “production”) from the hydrocarbon-bearing layer of the formation 312. As the well 311 is drilled through the formation 312, portions of the well may be cased with a casing (extending from the surface of the well) or a liner (extending downhole from an end of a previously installed casing or liner) to line the wellbore wall. The terms “open hole,” “borehole,” and “wellbore” may be used interchangeably and refer to an uncased portion of a well.

In some embodiments, the well system 310 may include a rig 314 positioned above an opening to the well 311, a well sub-surface system 315, and a well control system 317. The well control system 317 may control various operations of the well system 310, such as well production operations, well drilling operations, well completion operations, well maintenance operations, and reservoir monitoring, assessment, and development operations.

The rig 314 may hold equipment used to drill a borehole to form the well 311. Major components of the rig 314 may include drilling fluid tanks, drilling fluid pumps (e.g., rig mixing pumps), a derrick or mast, drawworks, a rotary table or top drive, drill string, power generation equipment and auxiliary equipment.

In a drilling operation, drilling fluid 302 may be pumped from a drilling fluid source 304, which may include an invert oil-based drilling fluid formulation as described herein. In accordance with one or more embodiments of the present disclosure, the invert oil-based drilling fluid formulation may be pumped downhole as the drilling fluid 302 and circulated through the well 311.

The method 200 includes, at block 220, circulating the invert emulsion oil-based drilling fluid formulation in the wellbore. During circulation, the wellbore conditions may be maintained such that the invert emulsion oil-based drilling fluid formulation provides a stable rheological property including one or more of viscosity, yield point, low shear yield point, plastic viscosity, gel strength, and electrical stability for a period up to about 12 to 120 hours.

One or more sections of the wellbore may be at HPHT conditions (“HPHT section”). Wellbore conditions are maintained for a period. The period may be up to about 12 to 120 hours, for example. “Maintaining wellbore conditions” relating to drilling fluid means that drilling operations may proceed, stop, or stop and resume. In this instance, drilling operations may include but are not limited to pumping, circulating, pressurizing, depressurizing, drilling, removing cuttings, sealing, cooling, lubricating, transmitting energy (hydraulic and otherwise), maintaining wellbore stability, and other techniques known in the art.

While maintaining wellbore conditions, the formulation may provide a rheological property of the invert emulsion oil-based drilling fluid that may be stable for the duration of the previously described step where wellbore conditions are maintained. The rheological property of the drilling fluid may include but is not limited to viscosity at one or more shear rate, yield point (“YP”), low shear yield point (“LSYP”), plastic viscosity (“PV”), gel strength, electrical stability, and combinations thereof. The time period that the formulation will maintain the rheological property of the drilling fluid is 12-24 hours or more. An invert emulsion mud may be stable for a period of days, where stability relates to maintaining the rheological property of the drilling fluid.

A viscosity may be measured at a shear rate ranging from 3 rpm to 600 rpm. The viscosity may be measured using a FANN® Model 35 viscometer. The viscosity relative to a shear rate may vary and is based on the organophilic clay-based viscosifier concentration, a mud weight, a base oil, a concentration of solids, an oil to water ratio, and other known variables.

A yield point (YP) may be measured. The YP is a parameter from the Bingham Plastic rheology model. The YP may be determined by extrapolating the Bingham Plastic rheology model to a shear rate of zero. This may represent the stress required to move the fluid. The YP may be expressed in the units of lb/100 ft². The YP may indicate the cuttings carrying capacity of the invert emulsion fluid (IEF) through the annulus. The carrying capacity may be related to the IEF's hole cleaning ability. A YP greater than 15 lb/100 ft² may indicate a superior cleaning capacity. The yield point may be in a range from 10 to 40 lb/100 ft².

A plastic viscosity (PV) may be measured. The PV is a parameter from the Bingham Plastic rheology model. The PV may represent the viscosity of a fluid when extrapolated to an infinite shear rate. The PV may be expressed in units of centipoise (cP). The PV may indicate the type and concentration of solids in the IEF. For example, solids may include drill solids, weighting agents, viscosifiers, or filtration control agents. In one or more embodiments, a low PV is preferred.

A yield stress may be measured. The yield stress or Tau0 is a parameter from the Herschel Buckley rheology model. The Tau0 may be determined by fitting the Herschel Buckley model to a shear stress versus a shear rate curve. This may correspond to readings plotted against a corresponding rpm determined on a standard oilfield viscometer. The Tau0 may be expressed in the units of lb/100 ft². The Tau0 may indicate the susceptibility of the IEF to barite sag where a high Tau0 is expected to deliver a sag resistant IEF. The Tau0 may be estimated by calculating a low shear yield point value (LSYP) value from relating a viscosity reading at 3 rpm to a viscosity reading at 6 rpm. A LSYP equal to or greater than 7 lb/100 ft² may be considered superior for drilling. In one or more embodiments, the LSYP value may range from 7 to 20 lb/100 ft².

A gel strength may be measured. The gel strength may be expressed in units of lb/100 ft². The gel strength measurement may be recorded using a viscometer at 3 rpm reading. A second reading may be recorded after stirring the drilling fluid at 600 rpm to break a gel. The first reading may be recorded after the drilling fluid is in a static condition for 10 seconds. The second reading may be for 10 minutes. 10 second and 10 minute gel strength-reading may indicate whether the drilling fluid may form a gel during extensive static periods. If the drilling fluid has a high gel strength, it may require a high pump pressure in order to break circulation after the drilling fluid is static for the extensive static period. In one or more embodiments, the gel strength may range from 7 to 25 lb/100 ft².

An electrical stability may be measured. The electrical stability (ES) of an oil-based drilling fluid mud is a property related to its emulsion stability and oil-wetting capability. ES may be determined by applying a voltage-ramped, sinusoidal electrical signal across a pair of parallel flat-plate electrodes immersed in the drilling fluid. The resulting current may remain low until a threshold voltage is reached, whereupon the current rises very rapidly. This threshold voltage may be referred to as the ES of the drilling fluid and is defined as the voltage. At this voltage, conduction between the two electrodes occurs resulting in a rapid increase in current. When the current reaches 61 micro-amps, the value of the peak voltage at this point may be measured and reported as the ES value for the drilling fluid. In one or more embodiments, the electrical stability may range from 400 to 2000 volts. For example, the electrical stability may range from a lower limit of one of any of 400, 800, and 1200 volts to an upper limit of one of any of 1200, 1600, and 2000 volts, where any lower limit may be combined with any compatible upper limit.

Embodiments of the present disclosure may provide at least one of the following advantages. The composition and method described herein which includes the combination of an organophilic clay and a fatty dimer amine may result in a low-end rheology for improved hole cleaning and barite sag resistance. The synergistic combination of the organophilic clay and the fatty dimer amine may result in a drilling fluid formulation with low PV and high LSYP which may have minimal impact on equivalent circulating densities and higher rates of penetrations.

### EXAMPLES

### Example 1: Drilling Fluid Formulation

97 pounds per cubic feet (pcf) oil-based drilling fluids with an oil-to-water ratio (OWR) of 80:20 and CaCl₂) water phase salinity (WPS) concentration of 250K parts per million (ppm) were formulated for the study. Priamine® 1074 which is C36 fatty dimer amine was obtained from Croda. Three different fluids were formulated. Fluid 1 was formulated with 4 parts per billion (ppb) of organoclay and in the absence of C36 fatty dimer amine, Fluid 2 was formulated with C36 fatty dimer amine and in the absence of organoclay while Fluid 3 was formulated with a combination of organoclay and Priamine® 1074. Formulations of the three fluids are given in Table 1.

TABLE 1
97 pcf oil-based drilling fluids formulation hot rolled at 300 °F

| | Mixing Time, | | | |
|---|---|---|---|---|
| Formulation | min | Fluid 1 | Fluid 2 | Fluid 3 |
| Mineral oil, ppb | | 161.3 | 161.3 | 161.3 |
| Primary emulsifier, ppb | 5 | 8.0 | 8.0 | 8.0 |
| Secondary emulsifier, ppb | 5 | 4.0 | 4.0 | 4.0 |
| Lime, ppb | 5 | 6.0 | 6.0 | 6.0 |
| Organoclay, ppb | 5 | 4.0 | 0.0 | 4.0 |
| Organophilic lignite, ppb | 5 | 53.3 | 53.3 | 53.3 |
| CaCl2, ppb | 5 | 18.6 | 18.6 | 18.6 |
| Water, ppb | 5 | 6.0 | 6.0 | 6.0 |
| RevDust, ppb | 5 | 20.0 | 20.0 | 20.0 |
| Marble (fine), ppb | 5 | 0.0 | 0.0 | 0.0 |
| Barite, ppb | 5 | 280.0 | 280.0 | 280.0 |
| PRIAMINE ® 1074, ppb | 5 | 0.0 | 5.0 | 5.0 |

### Example 2: Rheology, Filtration, and Electrical Stability Testing

The Fluids were hot rolled at 300 °F and 200 psi pressure for 16 hours. Rheology measurements were performed on Fann 35 rheometer at 120 °F. High pressure and high temperature filtration tests were carried out at 250 °F and 500 psi differential pressure. Emulsion stability for the three fluids was measured at 120 °F using an Electrical Stability Tester, Model 23D (Fann). Rheology, filtration, and electrical stability test results are given in Table 2.

TABLE 2
Rheology and fluid loss test results
of 97 pcf oil-based drilling fluids

| Rheological properties | Fluid 1 | Fluid 2 | Fluid 3 |
|---|---|---|---|
| 600 rpm | 51 | 45 | 63 |
| 300 rpm | 30 | 27 | 41 |
| 200 rpm | 23 | 21 | 32 |
| 100 rpm | 16 | 13 | 22 |
| 6 rpm | 7 | 5 | 10 |
| 3 rpm | 6 | 4 | 9 |
| PV | 21 | 18 | 22 |
| YP | 9 | 9 | 19 |
| LSYP | 5 | 3 | 8 |
| GELS 10 sec | 7 | 6 | 11 |
| GELS 10 min | 8 | 11 | 18 |
| HTHP fluid loss, ml, 250 °F | 2.5 | 3.2 | 1.8 |
| Emulsion stability, 120 °F, Volt | 1020 | 910 | 1444 |

The rheology of the fluid was characterized in terms of PV (plastic viscosity), YP (yield point), and LSYP (low shear yield point). Both PV and YP were calculated using 300 revolutions per minute (rpm) and 600-rpm shear rate readings on a standard oilfield viscometer as given in Equations 1 and 2 below.

PV=(600 rpm reading)−(300 rpm reading) (Equation 1)

YP=(300 rpm reading)−PV (Equation 2)

LSYP was calculated using 300 revolutions per minute (rpm) and 600-rpm shear rate readings on a standard oilfield viscometer as given in Equation 3 below.

LSYP=[2×(3 rpm reading)]−(6 rpm reading) (Equation 3)

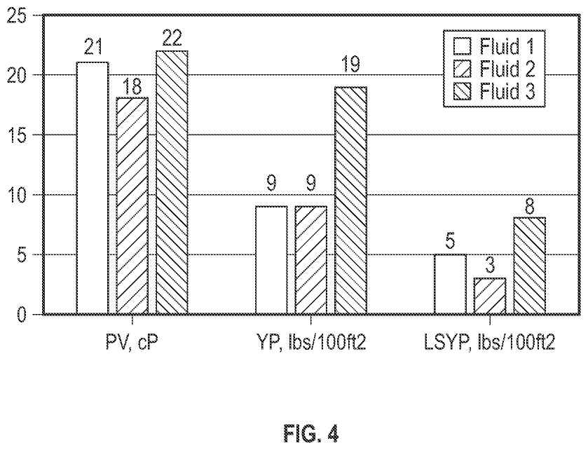

FIG. 4 shows the performance of three different 97 pcf oil-based drilling fluids formulated using organoclay and Priamine® 1074 as rheology modifiers. The results show that a significant improvement in rheological properties was obtained for Fluid 3. The plastic viscosity (PV) of Fluid 3 increased by 4.8% whereas the yield point (YP) and low shear yield point (LSYP) increased by 111.1% and 60% respectively as compared to Fluid 1. The plastic viscosity (PV) of Fluid 3 increased by 22% whereas the yield point (YP) and low shear yield point (LSYP) increased by 111.1% and 166.7% respectively as compared to Fluid 2. The results show that while the PV increased insignificantly, a significant increase in YP and LSYP was observed in Fluid 3 as compared to Fluids 1 and 2. These results show that Fluid 3 with a low PV and high YP and LSYP would ensure better hole cleaning and have good cuttings carrying capacity. Also, the emulsion stability values for Fluid 3 were higher as compared to Fluids 1 and 2, respectively.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A composition of an invert emulsion oil-based drilling fluid formulation comprising:
an invert emulsion comprising an oil phase and an aqueous phase, the oil phase including an oleaginous fluid;
a solid viscosifier that is an organophilic clay-based viscosifier; and
a liquid viscosifier that is a fatty dimer amine.

2. The composition of claim 1, wherein the invert emulsion oil-based drilling fluid formulation does not include carboxylic acids.

3. The composition of claim 1, wherein the invert emulsion oil-based drilling fluid formulation does not include ureas.

4. The composition of claim 1, wherein the oleaginous fluid includes a dearomatized mineral oil.

5. The composition of claim 4, wherein the dearomatized mineral oil is Safra oil.

6. The composition of claim 1, wherein the aqueous phase is a calcium chloride anhydride-based brine.

7. The composition of claim 1, wherein the organophilic clay-based viscosifier is organo-montmorillonite, organo-sepiolite, organo-palygorskite, organo-hectorite, or organo-attapulgite.

8. The composition of claim 1, wherein the liquid viscosifier is a C36 fatty dimer amine consisting of (1E,19E)-10,11-dioctylicosa-1,19-diene-1,20-diamine (Priamine® 1074).

9. The composition of claim 1, further comprising one or more selected from the group consisting of a weighting agent, barite; a friction reducer; a filtration control agent; an emulsion activator; a primary emulsifier; and a secondary emulsifier.

10. A method of introducing a drilling fluid into a wellbore, comprising:
introducing an invert emulsion oil-based drilling fluid formulation comprising an oil phase, an aqueous phase, a solid viscosifier including an organophilic clay-based viscosifier, and a liquid viscosifier including a fatty dimer amine in the wellbore, and
circulating the invert emulsion oil-based drilling fluid formulation in the wellbore.

11. The method of claim 10, wherein the invert emulsion oil-based drilling fluid formulation does not include carboxylic acids.

12. The method of claim 10, wherein the invert emulsion oil-based drilling fluid formulation does not include ureas.

13. The method of claim 10, wherein the liquid viscosifier is a C36 fatty dimer amine consisting of N,N′-bis(2-aminoethyl)-1,18-octadecanediamine (Priamine® 1074).

14. The method of claim 10, wherein the organophilic clay-based viscosifier is added to the invert emulsion oil-based drilling fluid formulation in an amount ranging from 0.1 to 20 ppb.

15. The method of claim 10, wherein the fatty dimer amine is added to the invert emulsion oil-based drilling fluid formulation in an amount ranging from 0.1 to 20 ppb.

16. The method of claim 10, where the invert emulsion oil-based drilling fluid formulation further comprises one or more selected from the group consisting of a weighting agent, a friction reducer, a filtration control agent, an emulsion activator, a primary emulsifier, and a secondary emulsifier.

17. The method of claim 10, where introducing the invert emulsion oil-based drilling fluid formulation yields a yield point in a range from 10 to 40 lb/100 ft².

18. The method of claim 10, where introducing the invert emulsion oil-based drilling fluid formulation yields a low shear yield point in a range from 7 to 20 lb/100 ft².

19. The method of claim 10, where introducing the invert emulsion oil-based drilling fluid formulation yields an electrical stability in a range from 400 to 2000 volts.
